(19) United States
(12) Patent Application Publication
(10) Pub. No.: US 2024/0428486 A1
(43) Pub. Date: Dec. 26, 2024

(54) ANNOTATIONS FOR GRAPHIC DESIGN SYSTEMS

(71) Applicant: Figma, Inc., San Francisco, CA (US)

(72) Inventors: Emil Sjölander, San Francisco, CA (US); Oscar Nilsson, San Francisco, CA (US); Kris Rasmussen, San Francisco, CA (US); Avantika Gomes, San Francisco, CA (US); Sho Kuwamoto, San Francisco, CA (US); Jessica Leary, San Francisco, CA (US)

(21) Appl. No.: 18/751,084

(22) Filed: Jun. 21, 2024

Related U.S. Application Data
(60) Provisional application No. 63/522,411, filed on Jun. 21, 2023.
(60) Provisional application No. 63/522,526, filed on Jun. 22, 2023.

(51) Int. Cl. G06T 11/60

(52) U.S. Cl. CPC G06T 11/60

(57) ABSTRACT

A graphic design system maintains a graphic design data set for a graphic design, where the graphic design data set is structured as a collection of layers. In response to a user interaction with a selected layer of the collection, the graphic design system generates an annotation that displays, or otherwise indicates or is based on, a selected attribute of the selected layer. Further, the graphic design system logically links the annotation with the selected attribute. As a result, an update to a selected layer of the collection automatically updates the annotation.

### RELATED APPLICATIONS

This application claims benefit of priority to each of Provisional U.S. Patent Application No. 63/522,411, filed Jun. 21, 2023; and to Provisional U.S. Patent Application No. 63/522,526, filed Jun. 22, 2023; both of the aforementioned priority applications being hereby incorporated by reference in their respective entirety.

### TECHNICAL FIELD

Examples described herein relate to a graphic design system, and more specifically to annotations for graphic design systems.

### BACKGROUND

Software design tools have many forms and applications. In the realm of application user interfaces, for example, software design tools require designers to blend functional aspects of a program with aesthetics and even legal requirements, resulting in a collection of pages which form the user interface of an application. For a given application, designers often have many objectives and requirements that are difficult to track.

Developers are often unfamiliar with the specifics of the graphic design, which in turn can be intricate and heavily detailed. The unfamiliarity can be a source of the inefficiency for developers, who often have to look carefully of the graphic design, view annotations from designers, and write code with the specifics in mind. Not only can the task of developers be efficient, the level of detail that is often included with the graphic design can make the developers task error-prone. For example, developers can readily miss read pixel distances between object, corner attribute, and other attributes which may be difficult to view without care.

### BRIEF DESCRIPTION OF DRAWINGS

FIG. 1 illustrates a graphic design system for creating annotations, according to one or more embodiments.

FIG. 2A illustrates an example method for generating an attribute-linked annotation, according to one or more embodiments.

FIG. 2B illustrates an example method for creating an attribute object that is pinned to a layer of a graphic design, according to one or more embodiments.

FIG. 3 illustrates an example design interface for implementing an annotation object, according to some embodiments.

FIG. 4A through FIG. 4C illustrate examples of a design interface that includes a graphic design on which attribute-linked annotations can be provided, according to one or more embodiments.

FIG. 5A through FIG. 5D illustrate an example design interface for enabling users to create attribute-linked annotations for graphic designs, according to one or more embodiments.

FIG. 5E illustrates an example design interface that is implemented in an alternative mode where attribute-linked annotations are rendered or otherwise made available, according to one or more embodiments.

FIG. 6 illustrates a computer system on which one or more embodiments can be implemented.

FIG. 7 illustrates a user computing device for use with one or more examples, as described.

### DETAILED DESCRIPTION

In examples, a graphic design system maintains a graphic design data set for a graphic design. The graphic design data set structures the graphic design as a collection of layers, where each layer corresponds to an object, a group of objects or a type of object, and each layer is associated with a set of attributes, including a text identifier. In response to a user interaction with a selected layer of the collection, the graphic design system generates an annotation that displays, or otherwise indicates or is based on, a selected attribute of the selected layer. Further, the graphic design system logically links the annotation with the selected attribute. As a result, an update to a selected layer of the collection automatically updates the annotation.

In examples, the terms attribute and property are interchangeable. In some examples, an attribute (or property) value can be formatted as a numeric or text value. Other types of values are possible. For example, in the case of color, the value can be expressed as hexadecimal, Hue, Saturation, or Lightness (HSL) and/or as a sample.

In examples, the graphic design system provides multiple rendering modes to view a graphic design. The multiple modes can include a design mode (e.g., where annotations are hidden) and a developer mode. In a developer mode, all annotations created for the graphic design are viewable. Thus, for a particular portion of a graphic design being viewed, a user can view all annotations that have been created for that portion of the graphic design, simply by toggling a design interface of the graphic design system from a first mode (e.g., design mode) to a developer mode.

As described, annotations can be linked to one or more design elements, a layer, and/or an attribute value. Annotations that are linked are also automatically updated based on modifications to the graphic design. By way of example, when an attribute or measurement referenced in an annotation is modified as a result of an edit to the graphic design system, the annotation is also changed automatically to reflect the modified attribute value or measurement.

One or more embodiments described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more embodiments described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some embodiments described herein can generally require the use of computing devices, including processing and memory resources. For example, one or more embodiments described herein may be implemented, in whole or in part, on computing devices such as servers, desktop computers, cellular or smartphones, tablets, wearable electronic devices, laptop computers, printers, digital picture frames, network equipment (e.g., routers) and tablet devices. Memory, processing, and network resources may all be used in connection with the establishment, use, or performance of any embodiment described herein (including with the performance of any method or with the implementation of any system).

Furthermore, one or more embodiments described herein may be implemented through the use of instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, embodiments may be implemented in the form of computer-programs, or a computer usable carrier medium capable of carrying such a program.

### System Description

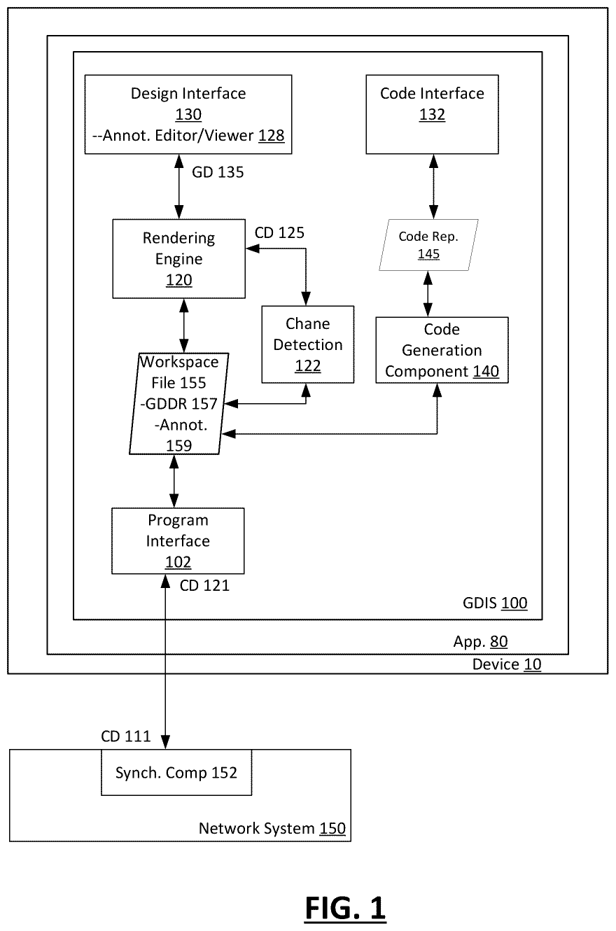

FIG. 1 illustrates a graphic design system, according to one or more examples. A graphic design system 100 (“GDS 100”) as described with FIG. 1 provides a tool for designers to create graphic user interface content (“graphic design 135”) for runtime and production environments. Among other aspects, the GDS 100 can be used to define, through, for example, constraints and logical relationships defined amongst design elements of the graphic user interface content, various types of interactions, state transitions and run-time behaviors that can take place when the graphic user interface content is implemented in a runtime or production environment. The graphic user interface content can be used to generate a code representation of the graphic user interface content, including the various constraints and logical relationships that define interactions, state transitions and behaviors of the runtime or production environments. As described with various examples, the GDS 100 enables designers to create annotations, to facilitate developers in developing code for implementing a runtime or production environment where the graphic design 135 is utilized.

According to examples, the GDS 100 can be implemented in any one of multiple different computing environments, including as a device-side application, as a network service, and/or as a collaborative platform. In examples, the GDS 100 can be implemented using a web-based application 80 that executes on a user device 10. In other examples, the GDS 100 can be implemented through use of a dedicated web-based application. As an addition or alternative, one or more components of the GDS 100 can be implemented as distributed system, such that processes described with various examples execute on both a network computer (e.g., server) and on the user device 10.

In examples, the GDS 100 includes processes that execute through a web-based application 80 that is installed on the computing device 10. The web-based application 80 can execute scripts, code and/or other logic to implement functionality of the GDS 100. Additionally, in some variations, the GDS 100 can be implemented as part of a network service, where web-based application 80 communicates with one or more remote computers (e.g., server used for a network service) to executes processes of the GDS 100.

In examples, a user device 10 includes a web-based application 80 that loads processes and data for providing the GDS 100 on a user device 10. The GDS 100 can include a rendering engine 120 that enables users to create, edit and update graphic design files. In variations, the GDS 100 can also include a code integration sub-system to combine, or otherwise integrate programming code, data, assets and other logic for developing a graphic design as part of a production environment.

In some examples, web-based application 80 retrieves programmatic resources for implementing the GDS 100 from a network site. As an addition or alternative, web-based application 80 can retrieve some or all of the programmatic resources from a local source (e.g., local memory residing with the computing device 10). The web-based application 80 may also access various types of data sets in providing functionality such as described with the GDS 100. The data sets can correspond to files and libraries, which can be stored remotely (e.g., on a server, in association with an account) or locally.

According to examples, a user of device 10 operates web-based application 80 to access a network site, where programmatic resources are retrieved and executed to implement the GDS 100. In some examples, the GDS 100 is provided for two classes of users—i) design users, who can initiate a session to implement the GDS 100 to view, create and edit graphic design 135, and ii) developers, who develop code for implementing the graphic design 135 in a runtime or production environment.

In examples, the web-based application 80 can correspond to a commercially available browser, such as GOOGLE CHROME (developed by GOOGLE, INC.), SAFARI (developed by APPLE, INC.), and INTERNET EXPLORER (developed by the MICROSOFT CORPORATION). In such examples, the processes of the GDS 100 can be implemented as scripts and/or other embedded code which web-based application 80 downloads from a network site. For example, the web-based application 80 can execute code that is embedded within a webpage to implement processes of the GDS 100. The web-based application 80 can also execute the scripts to retrieve other scripts and programmatic resources (e.g., libraries) from the network site and/or other local or remote locations. By way of example, the web-based application 80 may execute JAVASCRIPT embedded in an HTML resource (e.g., web-page structured in accordance with HTML 5.0 or other versions, as provided under standards published by W3C or WHATWG consortiums). In other variations, the GDS 80 can be implemented through use of a dedicated application, such as a web-based application.

The GDS 100 can include processes represented by programmatic interface 102, rendering engine 120, design interface 130, code interface 132 and code generation component 140. Depending on implementation, the components can execute on the user device 10, on a network system (e.g., server or combination of servers), or on the user device 10 and a network system (e.g., as a distributed process).

The programmatic interface 102 includes processes to receive and send data for implementing components of the GDS 100. Additionally, the programmatic interface 102 can be used to retrieve, from local or remote sources, programmatic resources and data sets which include a workspace file 155 of the user or user's account. In examples, the workspace file 155 includes one or more data sets (represented by “graphic design data set 157”) that represent corresponding graphic design 135, as rendered by the rendering engine 120. The workspace file 155 can include one or more graphic design data sets 157 which collectively define the graphic design 135 when rendered. The graphic design data set 157 can be structured as one or more hierarchical data structures. In some examples, the graphic design data set 157 can be structured to define a graphic design as a collection of layers and/or nodes, where each layer or node corresponds to an object, group of objects, or specific type of object. Further, in some examples, the graphic design data set 157 can be organized to include graphic designs on screens, where each graphic design including one or more cards, pages (e.g., with one canvas per page), or sections that include one or multiple pages.

According to an aspect, the programmatic interface 102 also retrieves programmatic resources that include an application framework for implementing the design interface 130. The design interface 130 can utilize a combination of local, browser-based resources and/or network resources (e.g., application framework) provided through the programmatic interface 102 to generate interactive features and tools that can be integrated with a rendering of the graphic design on a canvas. The application framework can enable a user to view and edit aspects of the rendered graphic design 135. In this way, the design interface 130 can be implemented as a functional layer that is integrated with a canvas on which a graphic design is provided.

The design interface 130 can detect and interpret user input, based on, for example, the location of the input and/or the type of input. The location of the input can reference a canvas or screen location, such as for a tap, or start and/or end location of a continuous input. The types of input can correspond to, for example, one or more types of input that occur with respect to a canvas, or design elements that are rendered on a canvas. Such inputs can correlate to a canvas location or screen location, to select and manipulate design elements or portions thereof. Based on canvas or screen location, a user input can also be interpreted as input to select a design tool, such as may be provided through the application framework. In implementation, the design interface 130 can use a reference of a corresponding canvas to identify a screen location of a user input (e.g., ‘click’). Further, the design interface 130 can interpret an input action of the user based on the location of the detected input (e.g., whether the position of the input indicates selection of a tool, an object rendered on the canvas, or region of the canvas), the frequency of the detected input in a given time period (e.g., double-click), and/or the start and end position of an input or series of inputs (e.g., start and end position of a click and drag), as well as various other input types which the user can specify (e.g., right-click, screen-tap, etc.) through one or more input devices.

In some examples, the rendering engine 120 and/or other components utilize graphics processing unit (GPU) accelerated logic, such as provided through WebGL (Web Graphics Library) programs which execute Graphics Library Shader Language (GLSL) programs that execute on GPUs. In variations, the web-based application 80 can be implemented as a dedicated web-based application that is optimized for providing functionality as described with various examples. Further, the web-based application 80 can vary based on the type of user device, including the operating system used by the user device 10 and/or the form factor of the user device (e.g., desktop computer, tablet, mobile device, etc.).

In examples, the rendering engine 120 uses the graphic design data set 157 to generate graphic design 135, where the graphic design 135 includes graphic elements, attributes and attribute values. Each attribute of a graphic element can include an attribute type and an attribute value. For an object, the types of attributes include, shape, dimension (or size), layer, type, color, line thickness, text size, text color, font, and/or other visual characteristics. Depending on implementation, the attributes reflect properties of two- or three-dimensional designs. In this way, attribute values of individual objects can define, for example, visual characteristics of size, color, positioning, layering, and content, for elements that are rendered as part of the design.

The graphic design 135 can organize the graphic design by screens (e.g., representing production environment computer screen), pages (e.g., where each page includes a canvas on which a corresponding graphic design is rendered) and sections (e.g., where each screen includes multiple pages or screens). The user can interact, via the design interface 130, with the design interface 130 view and edit the graphic design 135. The design interface 130 can detect the user input, the workspace file 155 and/or GDDR 157 can be updated based on the input, and the rendering engine 120 can update the graphic design 135 in response to the input. The rendering engine 120 can also implement navigational operations to increase or decrease magnification and/or pan left or right. In implementing such navigational operations, the rendering engine 120 can specify a magnification or portion of graphic design 135 for a user's viewport. The user can specify input to change a view of the graphic design 135 (e.g., zoom in or out of a graphic design), and in response, the rendering engine 120 updates the graphic design 135 to reflect the change in view.

The rendering engine 120 can also implement changes to the graphic design 135. The design interface 130 can detect the input, and the rendering engine 120 updates the graphic design data set 157 representing the updated graphic design 135. Additionally, the rendering engine 120 can update the graphic design 135 of the graphic design, such that the user instantly sees the change to the graphic design 135 resulting from the user's interaction.

### Collaborative Environment

In examples, the GDS 100 can be implemented as part of a collaborative platform, where graphic design 135 can be viewed and edited by multiple users operating different computing devices at locations. The user device of each collaborator can receive a local version of the workspace file 155, such that each user device renders graphic design 135 from the same workspace file 155. While the workspace file 155 of each collaborator is synchronized, each collaborator can independently view and edit the graphic design 135. As part of a collaborative platform, when the user edits graphic design 135, the changes made by the user are implemented in real-time to instances of the workspace file 155 on the user devices of the other collaborating users. Likewise, when other collaborators make changes to the graphic design 135, the changes are reflected in real-time with the workspace file 155 and graphic design data set 157. On each collaborator device, the rendering engine 120 can update the local version of the workspace file 155 to reflect, in real-time, changes to the graphic design 135, including changes made by other collaborators.

In implementation, when the rendering engine 120 implements a change to the graphic design data set 157, corresponding change data 111 representing the change can be transmitted to the network system 150. The network system 150 can implement one or more synchronization processes (represented by synchronization component 152) to maintain a network-side representation 151 of the graphic design. In response to receiving the change data 111 from the user device 10, the network system 150 updates the network-side representation 151 of the workspace file 155, and transmits the change data 111 to user devices of other collaborators. Likewise, if another collaborator makes a change to the instance of the workspace file 155 on their respective device, corresponding change data 111 can be communicated from the collaborator device to the network system 150. The synchronization component 152 updates the network-side representation 151 of the workspace file 155, and transmits corresponding change data 121 to the user device 10 to update their respective copies of the workspace files 155. On each collaborator device, the rendering engine 120 updates in real-time the graphic design 135 rendered from the corresponding copy of the workspace file 155.

### Change Data

In examples, the GDS 100 can include processes represented by change detection component 122 to record and/or detect changes to the graphic design data set 157. The change detection component 122 can track changes entered by, for example, a user of the computing device 10 via the design interface 130. As an addition or variation, the change detection component 122 can detect changes to graphic design data set 157 based on change data 121 received from the network system 150. The change detection component 122 can implement a set of changes to the graphic design 135 based on changes made by other collaborators.

Still further, the change detection component 122 can take snapshots at different instances of time, and generate a change data set 125 to reflect a series of updates to the graphic design 135 (and graphic design data representation or “GDDR 157”) over a given time period. For example, the change detection component 122 can compare snapshots of the graphic design data set 157 between a time period when a user last edited or viewed the graphic design 135 (e.g., end of prior day) and a present time when the user starts a new session (e.g., current day) to edit or view the graphic design. When a user starts a new session, the network system 150 updates the graphic design data set 157 with change data 121 that reflects updates to the graphic design from different collaborating users who may have worked on the workspace file at different times.

In examples, the rendering engine 120 generates visual indicators of the change data set 125 on the graphic design 135. The design interface 130 can implement the visual indicators as an additional layer, or with other functionality that allows a user to navigate across a design interface, such as from one point to another on a canvas, or from one page to another. The user can navigate from one point to the next by providing, for example, an input to view a “next” change, or a “previous” change. Based on the change data set 125, the design interface 130 can automatically locate points on the canvas or screen where design elements of the graphic design 135 have been changed (e.g., deleted, modified, added, etc.). Further, the rendering engine 120 can use the change data set 125 to show visually what change occurred, such as by making a prior version of the portion of the design interface viewable.

### Code Generation

In examples, the GDS 100 includes processes represented by code generation component 140 to generate code data for a code representation 145 of the graphic design 135. The code generation component 140 can include processes to access GDDR 157 of workspace file 155, and to generate code data that represent elements of the graphic design. The generated code data can include production environment executable instructions (e.g., JavaScript, HTML, etc.) and/or information (e.g., CSS (or Cascading Style Sheets), assets (e.g., elements from a library) and other types of data.

In some examples, the graphic design data set 157 is structured to define multiple layers, where each layer corresponds to one of an object, a group of objects or a specific type of object. In specific examples, the types of layers can include a frame object, a group of objects, a component (i.e., an object comprised of multiple objects that reflect a state or other variation between the instances), a text object, in image, configuration logic that implements a layout or positional link between multiple objects, and other predefined types of elements. For each layer, the code generation component 140 generates a set of code data that is associated or otherwise linked to the design element. For example, each layer of the graphic design data set 157 can include an identifier, and the code generation component 140 can, for each layer, generate a set of code data that is associated with the identifier of the layer. The code generation component 140 can generate the code representation 145 such that code line entries and elements of the code representation 145 (e.g., line of code, set of executable information, etc.) are associated with a particular layer of the graphic design 135. The associations can map code line entries of the code representation 145 to corresponding design elements (or layers) of the graphic design 135 (as represented by the graphic design data set 157). In this way, each line of code of the code representation 145 can map to a particular layer or design element of the graphic design. Likewise, in examples, each layer or design element can map to a line of code of the code representation 145 of the graphic design 135.

### Code Representation Rendering

In examples, the code interface 132 renders an organized presentation of code representation 145. For example, the code interface 132 can segment a presentation area into separate areas, including separate segments where production-environment executable code instructions are displayed (e.g., separate areas for HTML and CSS code). Further, the code interface 132 can include a separate segment to identify assets used in the graphic design, such as design elements that are part of a library associated with a library of an account associated with the user.

The code interface 132 can implement a combination of local, browser-based resources and/or network resources (e.g., application framework) provided through the programmatic interface 102 to generate a set of interactive features and tools for displaying code representation 145. In examples, the code interface 132 can enable elements of the code representation 145 to be individually selectable as input. For example, the user may select, as input, one or more of the following (i) a line of code, (ii) a portion of a line of code corresponding to an attribute, or (iii) portion of a line of code reflecting an attribute value. Still further, user can select program code data displayed in different areas, program code of different types (e.g., HTML or CSS), assets, and other programmatic data elements.

### Selecting Code to View Design Elements

The code interface 132 can detect user input to select a code element. In response to detecting user input to a specific code element, the code interface 132 can identify the associated design element(s) (or layer) associated with that code element to the design interface 130. For example, the code interface 132 can identify a particular layer that is indicated by the selection input of the user. The code interface 132 can indicate the identified layers or design elements to the design interface 130, to cause the design interface 130 to highlight or display in prominence the design element(s) that are associated with the selected code elements. In some examples, the design interface 130 can visually indicate design element(s) associated with code elements that are selected through the code interface 132 in isolation, or separate from other design elements of the graphic design. In such case, other design elements of the graphic design can be hidden, while the associated design element is displayed in a window of the design interface 130. In this way, when the user interacts with the code interface 132, the user can readily distinguish the associated design element from other design elements of the graphic design.

### Selecting Code to Navigate to Design Element

Further, the selection of a code element in the code interface 132 can cause the design interface 130 to navigate to the particular set of design elements that are identified by a selected code element. For example, the code interface 132 can identify the layer that is selected by the user input, and the design interface 130 can navigate a view of the graphic design 135 to a canvas location where the associated design element is provided. As an addition or variation, the design interface 130 can navigate by changing magnification level of the view, to focus in on specific design elements that are associated with the identified design element.

### Synchronizing Design and Code Interface

In examples, the design interface 130 and the code interface 132 can be synchronized with respect to the content that is displayed through each interface. For example, the code interface 132 can be provided as a window that is displayed alongside or with a window of the design interface 130. In an aspect, the code interface 132 displays code elements that form a portion of the code representation, where each code element is associated with a layer or design element having a corresponding identifier. In turn, the design interface 130 uses the identifiers of the layers/design elements to render the design elements of the graphic design 135 that coincide with the code elements of the code representation 145, as displayed by the code interface 132.

Further, the GDS 100 can implement processes to keep the content of the design interface 130 linked with the content of the code interface 132. For example, if the user scrolls the code data displayed through the code interface 132, the design interface 130 can navigate or center the rendering of the graphic design 135 to reflect the code elements that are in view with the code interface 132. As described, the design interface 130 and the code interface 132 can utilize a common set of identifiers for the layers or design elements, as provided by the graphic design data set 157.

### Modifying Graphic Design Through Code Interface

In examples, a user of device 10 can modify the graphic design 135 by changing the code representation 145 using the code interface 132. For example, a user can select a code element displayed through the code interface 132, and then change an attribute, attribute value or other aspect of the code element. The input can identify and change the layer or design element as defined in a structure defined by the graphic design data set 157. In response, the rendering engine 120 can update the rendering of the graphic design 135, to reflect the change made through the code interface 132. In this way, a developer can make real-time changes to, for example, a design interface to add, remove or otherwise modify (e.g., by change to attribute or attribute value) a layer or design element.

### Viewing and Modifying Code Elements Through Design Interface

Additionally, in examples, a user can select design elements of the graphic design 135 through interaction with the design interface 130. For example, a user can select or modify a layer of the graphic design. The design interface 130 can identify the layer for the code interface 132. In response, the code interface 132 can highlight or otherwise visually distinguish code elements (e.g., lines of code) that are associated with the identified design element from a remainder of the code representation 145. In this way, a developer can readily inspect the code elements generated for a design element of interest by selecting a design element, or a layer that corresponds to the design element in the design interface 130, and viewing the code generated for the selected element or layer in the code interface 132.

Further, in examples, the user can edit the graphic design 135 through interaction with the design interface 130. The rendering engine 120 can respond to the input by updating the graphic design 135 and the graphic design data set 157. When the graphic design data set 157 is updated, the code generation component 140 can update the code representation 145 to reflect the change. Further, the code interface 132 can highlight, display in prominence or otherwise visually indicate code elements that are changed as a result of changes made to the graphic design 135 via the design interface 130.

### Code Generation to Reflect Changes to Design Interface

In additional examples, the change detection component 122 can determine a change in the graphic design 135, and the changes in the graphic design can be indicated in the graphic design data set 157 and the code representation 145. For example, in a collaborative environment, the graphic design data set 157 can change between sessions of a user of the device 10 as a result of work done by other collaborators. In examples, the design interface 130 can indicate design elements of the graphic design that changed from a previous point in time (e.g., such as between user sessions).

In examples, the code generation component 140 can generate code to update the code representation 145 based on the change data set. The code interface 132 can indicate code elements of the graphic design 135 that are new or modified from the prior user's session. In this way, a designer can view what has changed between graphic designs. Likewise, a developer can view corresponding changes to the code representation 145, which may be the result of changes made by a designer to the graphic design 135.

### Annotations

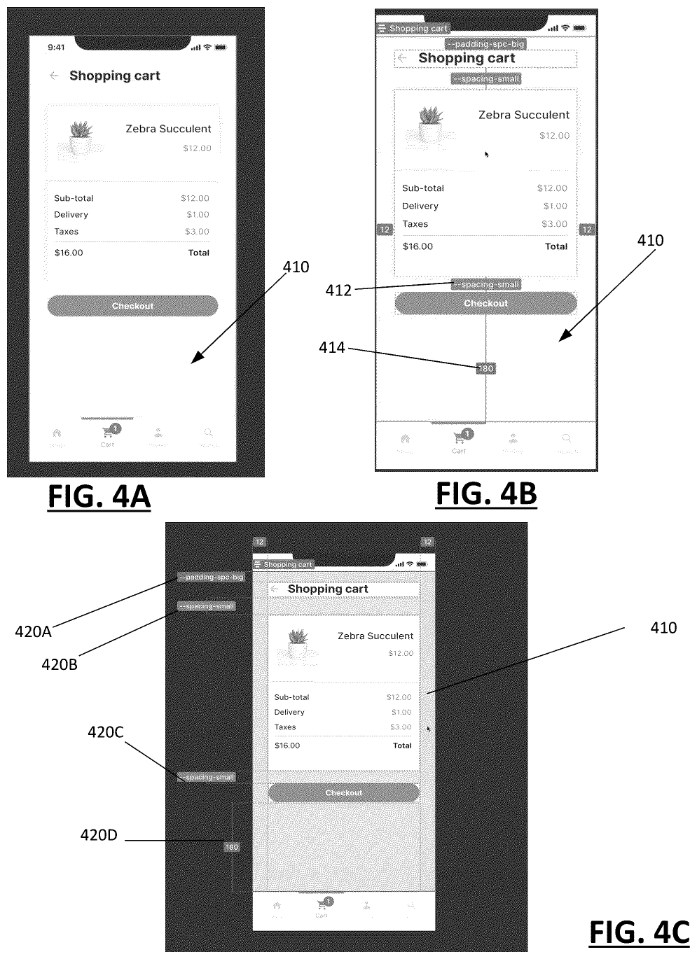

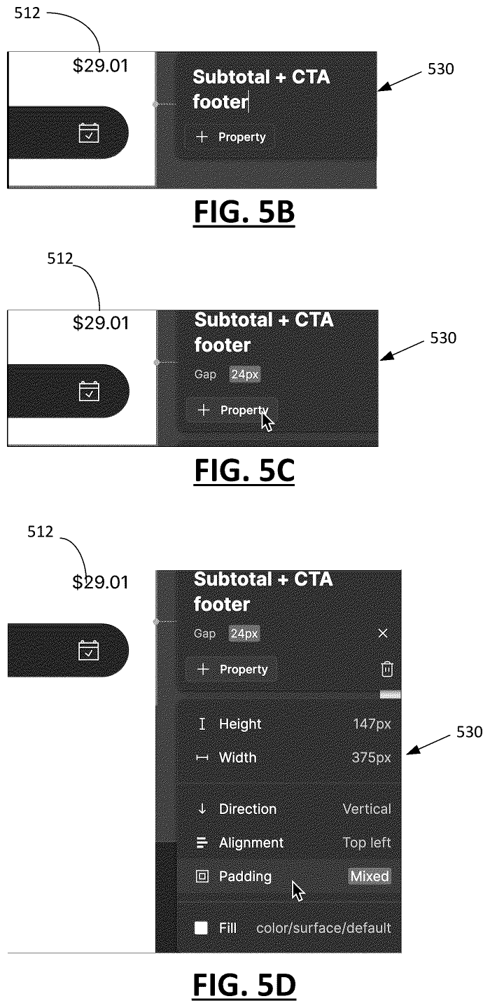

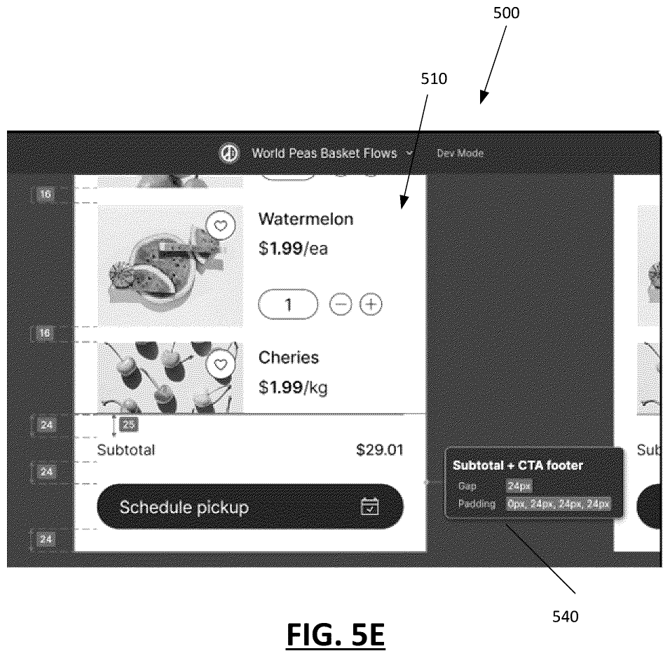

In examples, the rendering engine 120 generates annotations 159 for a graphic design 135 based on user input. As described with examples, an annotation is a content item that can be displayed with the graphic design 135, but the annotation itself is not part of the graphic design 135, meaning that the annotation forms no part of content rendered as part of a corresponding runtime or production environment. Based on implementation, the GDS 100 can enable a user to create one or multiple annotations of different types, including (i) annotations that are structured as self-contained notes or messages, (ii) annotations that display attribute values of a selected portion (e.g., node, design element, etc.) of the graphic design 135, and/or (iii) annotations that display information about a selected portion of the graphic design 135, such as a measurement (e.g., spacing between design elements, etc.). Specific examples of annotations of different types include annotation objects (e.g., see FIG. 3) and attribute-linked annotations (e.g., see FIG. 5E).

A user (e.g., design user) can provide input (e.g., selection of annotation tool, designated annotation interaction, etc.) to mark a location where an annotation 159 is to be rendered. The location can be tied to, for example, a design element or layer (or node representing the design element), a location or area of a canvas, or a portion of the graphic design 135. In examples, an annotation 159 can be rendered as, for example, as a separate layer of content (e.g., overlay).

In examples, the GDS 100 is configured to render a graphic design 135 in multiple rendering modes, including a first mode (e.g., design mode) and a second mode (e.g., developer mode). Annotations can include annotation objects and/or attribute-linked annotations. An annotation object can include a structure (e.g., note) and can be manipulated when displayed. An attribute-linked annotation displays an attribute value, or is based on one or more attribute values. An attribute-linked annotation may or may not include structure and additional content (e.g., text from a user). An attribute-linked annotation is also modified automatically in response to modifications to the graphic design that result in a change to the referenced attribute(s) of the annotation.

While annotations can be viewed by a designer or developer, the annotations can also be ignored, by default, for purpose of integrating either the graphic design or code representation in a production environment. In examples, annotations can be included with graphic designs to facilitate communication between developers and designers, such as in the case of a ‘hand-off’, where developer(s) view the graphic design to develop code for implementing the graphic design in a production environment.

In some examples, an annotation object can be generated as a graphic element that is created through the design interface 130. Each annotation object 131 can be generated as a type of object (e.g., formatted text frame) that can be pinned to an object and/or canvas location. A designer can create an annotation object using a tool provided with the design interface 130. For example, the user can operate the tool to create an object that is configured to include text content. The user can provide text content for the annotation object, and provide input to pin the annotation object to an object or canvas location. Once the annotation object is pinned to an object, the annotation object maintains a spatial relationship with the pinned object. For example, if the pinned object is moved or resized on the canvas, the annotation object can be moved to maintain the spatial relationship with the pinned object. As an addition or variation, the annotation object can be displayed as a graphic indicator that is visually connected to the pinned object.

In examples, an annotation object can be created via the design interface 130 to automatically include a set of attributes, such as object type (e.g., text object), and a set of properties that control the behavior of annotations. By default, the annotation object can include a property that defines a visibility state of the annotation object. A user can toggle the value of the visibility property to cause the annotation object to switch between a visible state and a hidden state.

### Annotation Viewer

In examples, the design interface 130 includes an annotation viewer/editor 128 to view and edit annotations 159 that are created for the graphic design. The annotation viewer/editor 128 can enable the user to view the annotation objects 159 separate or distinct from the graphic design 135. For example, the rendering engine 120 can enable annotations 159 (e.g., attribute objects or attribute-linked attributes) to be viewed in a foreground or other prominence relative to the graphic design. Still further, in other variations, the annotation viewer/editor 128 can enable the user to view the annotations with the graphic design being hidden.

As an addition or variation, in examples, the annotation viewer/editor 128 can enable the user to navigate between annotation objects. For example, the user can interact with the annotation viewer/editor 128 to navigate the user from a first location on the canvas where a first annotation object 159 is pinned (e.g., by canvas location or design element located at that location) to a second location on the canvas where a second annotation object is pinned. When the annotation viewer/editor 128 navigates to a particular annotation object, the canvas may be traversed, and/or the magnification setting may be adjusted in order to render a next annotation object.

In determining a sequence to navigate annotation objects, the annotation viewer/editor 128 calculates a screening or canvas distance between the annotation objects. The locations of the annotation object can be based on, for example, the location of the canvas location or design element to which the annotation object is pinned. In this way, navigation can employ a proximity based navigation, where proximity is based on the calculated distance between two annotation objects along the X and Y axes. The proximity-based navigation enables a user to view a first annotation object, then navigate to a second annotation object, where the second annotation object is determined to be nearest amongst all other annotation objects to the first annotation object. Depending on implementation, the distance between annotation object can be calculated as a canvas distance or a display (or screen) distance. In the course of handing the graphic design off to a developer, the mechanism for navigating annotations can enable developers to scan through highlighted or trouble spots of the graphic design by area, thereby enabling the designer to better understand the context of the annotation object.

Further, when the annotation is pinned to a designated object, the annotation object can be maintained with the designated object even if the designated object is repositioned or resized on the canvas. In some examples, the user can select an annotation to view the object in the design interface. At the same time, the portion of the code representation that coincides with the pinned object can be displayed in the code interface 132. In this way, the user can view the content of the annotation to view instructions, comments, notes, or suggestions relating to the pinned design element and its code representation 145.

In some examples, the annotation viewer 128 can be provided when the design interface 130 is in a designated mode (e.g., developer mode). For example, the design interface 130 can be toggled from design mode to developer mode, and when in the developer mode, the attribute viewer 128 is visible. Still further, as shown and described with an example of FIG. 5D, an annotation tool can be provided at the selection of the user (e.g., through interaction with tool bar or right-click) to enable the user to create or edit an annotation.

### Attribute-Linked Annotations

In examples, an attribute linked annotation can be generated automatically, in response to user selection input, where the selection input specifies a rendered attribute of the graphic design 135. The attribute-linked annotations can be generated for attributes that include, for example, spacing or padding, font size, dimensional attributes, corner attributes, vertical or horizontal alignment, and/or dimensional attributes (e.g., width, height, etc.). As an addition or variation, annotations can be generated for attributes that include, for example, font size, text content, text attributes, color attributes and other types of attributes.

As described with examples, the design interface 130 can be implemented in alternative rendering modes for the graphic design 135. In the design mode, the graphic design 135 can be editable with attribute values hidden by default. In an alternative developer mode, the values of the attributes can be displayed adjacent to the graphic design. A user can interact with the displayed attributes by, for example, copying a rendered attribute value, or performing some other action (e.g., see FIG. 5A through FIG. 5D) to designate the particular attribute as being the subject of the annotation.

In response, the annotation viewer 128 (i) generates annotation, in the form of auto extracted characters that identify the attribute and attribute value, and (ii) pins a value adjacent to the layer where the interaction was received, where the value is based on the attribute value of the corresponding layer, as determined by the GDDR 157. In this way, if the subject layer is modified, to cause a change in its attribute, the contents of the annotation is also changed automatically by the GDS 100. Thus, for example, if the attribute represents spacing, then the corresponding content of the annotation can change if the spacing is adjusted. Similarly, the content of the annotation can change in response to other modifications, such as re-sizing, change in text or font, change on color, repositioning of the object, etc. In the latter case, the annotation may move on the canvas along with the layer that is associated with the annotation. Further, modifications to the graphic design 135 can be made by any of multiple users who collaborate on the graphic design 135. Any change to the graphic design 135 can cause an attribute-linked annotation to update, to reflect changes to attribute values of the graphic design that are referenced by the particular annotation.

As with other examples, attribute linked annotations enable developers to readily view aspects of the graphic design that may otherwise be difficult to see. Further, the annotations can be positioned adjacent to the specific region of the graphic design, where the developer's attention is required.

Annotation Filtering, Sorting and/or Searching

In examples, the annotation viewer 128 can include features to enable annotations (e.g., annotation object, attribute-linked annotation, etc.) to be filtered, sorted and/or searched. For example, with either type of annotation described, a user can filter the annotations by various criteria. A user can filter or sort attribute linked annotations by attribute type, by attribute value or other criteria. Likewise, a user can search for annotations by type or by their respective content (e.g., attribute property).

### Methodology

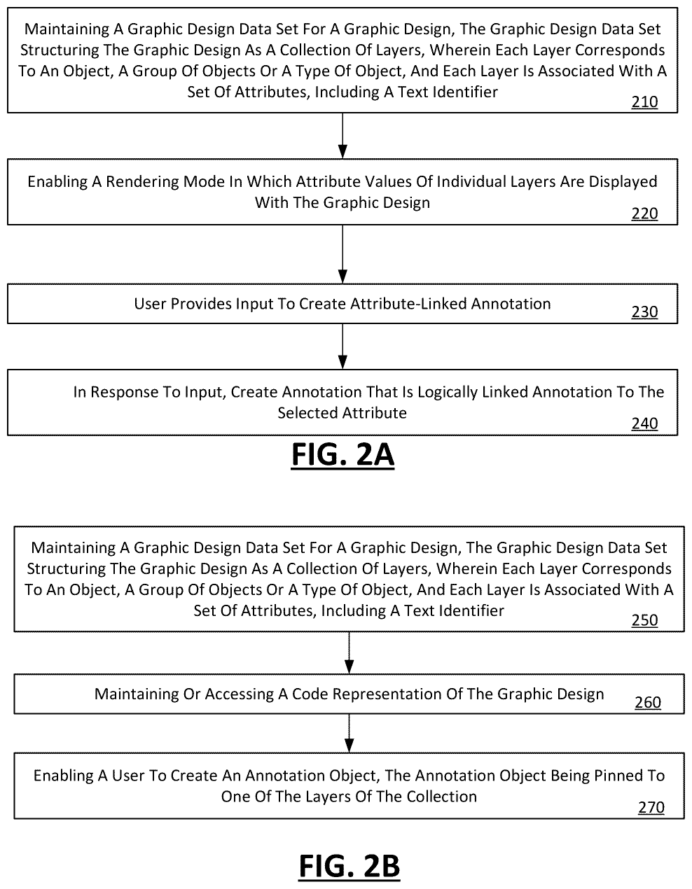

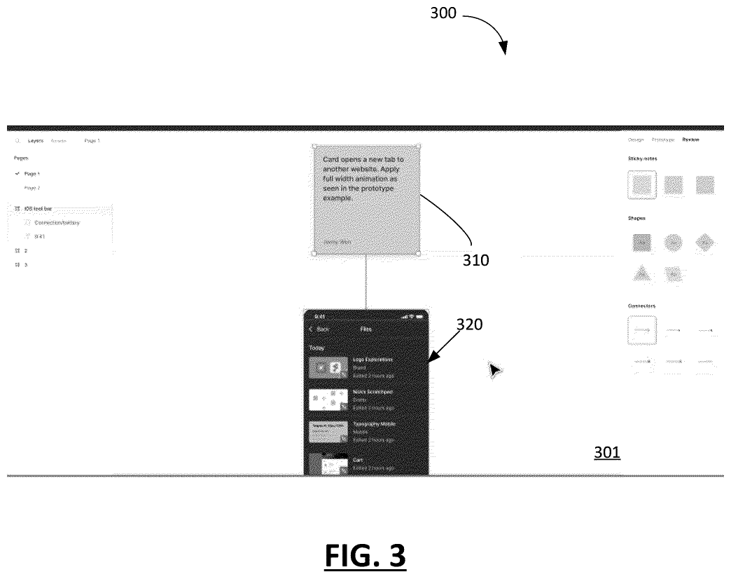

FIG. 2A illustrates a method for generating an attribute-linked annotation that is linked to a design element or layer of a graphic design, according to one or more examples. FIG. 2B illustrates a method for creating an attribute object that is pinned to a layer of a graphic design, according to one or more embodiments. Examples as described with FIG. 2A and FIG. 2B may be implemented using features and functionality such as described with the graphic design system, as shown and described with an example of FIG. 1.

With reference to FIG. 2A, in step 210, the GDS 100 maintains a graphic design data set for a graphic design. The graphic design data set structures the graphic design as a collection of layers, where each layer corresponds to an object, a group of objects (e.g., frame, parented or combined frames, etc.) or a specific type of object (e.g., a multistate component or element). Each layer can be associated with a set of attributes, including a text identifier.

In step 220, the GDS 100 enables a rendering mode where attribute values of individual layers are displayed with the graphic design. In examples, a design user can interact with the design interface to readily view attribute values of a graphic design. The design interface 130 can include a set of tools (e.g., menu) or mechanisms to display attributes of design elements. In an example, the attributes can be displayed as a layer (e.g., overlay), so that the attributes are displayed concurrently with the graphic design. As a variation, the attributes can be associated with corresponding markers or elements that are displayed to indicate the presence of attribute values for use with annotations, with the markers being interactive to view corresponding attribute values. In some examples, the design interface 130 is operable in multiple modes, including a design mode where annotations are hidden, and a developer mode where all annotations of a graphic design are visible. In the design mode, examples can further provide that a user can also select between alternative modes, including a sub-mode where the attribute values and measurements are persistently displayed as additional content (e.g., overlay) of the design interface.

In step 230, the user can provide input to cause the GDS 100 to create an attribute-linked annotation. In examples, the user can interact with one or more of (i) a select design element, (ii) a displayed attribute of a selected design element, and/or (iii) a marker that is indicative of an attribute reading of a selected design element. To create an attribute-linked annotation, examples provide that a user can interact with the design interface to select a design element of portion of the graphic design, and then interact with an annotation toolbar to view attribute values for the selection. The user can further interact with the annotation toolbar to select one or multiple attribute values, where each attribute value corresponds to a property of the graphic design (e.g., vertical or horizontal alignment, dimensional attributes, padding (e.g., amount of space between elements), fill attribute, etc.).

In step 240, the GDS 100 creates, in response to the user input (step 230), the attribute-linked annotation by logically linking the annotation with a select attribute value, as identified by the user input. Once the attribute-linked annotation is created, the attribute-linked annotation (i) displays attribute value for a select attribute of a design element or portion of a graphic design; and (ii) is linked to the displayed attribute, such that if user input causes the select attribute to change, the annotation is also changed to include the updated attribute value. In examples, the attribute-linked annotation is displayed when the design interface 130 is switched into a developer mode (e.g., from a design mode). This allows for developer users to use a modal selection to view annotations, concurrently with, for example, the developer interacting with a code interface 132 to view portions of the code representation 145.

With reference to FIG. 2B, in step 250, the GDS 100 maintains a graphic design data set for a graphic design. The graphic design data set structures the graphic design as a collection of layers, where each layer corresponds to an object, a group of objects (e.g., frame, parented or combined frames, etc.) or a specific type of object (e.g., a multistate component or element). Each layer can be associated with a set of attributes, including a text identifier. In step 260, the GDS 100 maintains, or accesses, a code representation of the graphic design. In some examples, the GDS 100 integrates an external code editor and/or repository to maintain a developer's code for implementing the graphic design in a production environment. In step 270, the GDS 100 enables the user to create an annotation object, where the annotation object is pinned to one or more layers of the graphic design. In examples, the annotation object can also be linked to portions of the code representation for the graphic design. In this way, when the annotation object is viewed in a developer mode, the GDS 100 can automatically navigate the user to a portion of the graphic design that is the subject of the annotation, while also navigating the code interface 132 to a portion of the code representation 145 for implementing the referenced portion of the graphic design.

In examples, the annotation object can include content obtained from the graphic design (e.g., attribute values), where in some variations, the content is automatically obtained. Additionally, in some variations, the annotation object can include content, generated by a designer or developer.

### Example Interfaces

FIG. 3 illustrates a design interface 300 for implementing an annotation object 310, according to some examples. The annotation object 310 can be pinned to a layer of the design interface 300, such as a top-level node or other type layer. The annotation object 310 can be linked a design element or layer 320. The content of the annotation object can include, for example, text content (e.g., manual input from user), such as a message from a designer to a developer. In some examples, the annotation object 320 is selectively displayed based on a mode of the design interface 300. For example, the design interface 300 can be toggled into a developer mode where the annotation objects of the graphic design are automatically rendered as an additional layer or overlay on the design interface 300. In examples, the annotation object 310 is linked to the corresponding design element or layer 320, such that changes to the design element or layer 320 cause the annotation object to be automatically updated. For example, if the design element or layer 320 is repositioned, the annotation object 320 is also repositioned. Further, if the annotation object 320 includes content such as an attribute of the referenced design element or layer 320, then changes to the graphic design 300 can cause the content of the annotation object 320 to change, so that the attribute values included in the annotation are automatically updated.

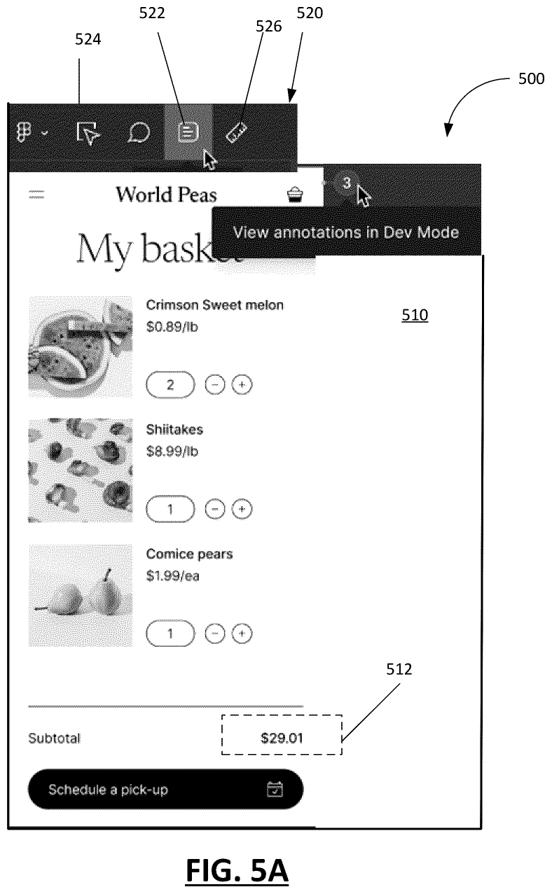

FIG. 4A through FIG. 4C illustrate examples of a design interface that includes a graphic design 410 on which attribute-linked annotations can be provided, according to one or more examples.

With reference to FIG. 4A and FIG. 4B, the design interface 400 is displayed in a first mode (e.g., design mode). In the design mode, any annotations that may have already been created are hidden. Further, a user (e.g., designer) can specify or otherwise create annotations. In FIG. 4B, the design interface 400 can implement a sub-mode where attributes 412, 414 of the design elements are displayed as a layer of content over the graphic design 410. In some examples, while the graphic design 410, a user can interact with the displayed attributes to create corresponding annotations.

With reference to FIG. 4C, the design interface 400 is shown to be toggled into a second alternative mode (e.g., developer mode), where attribute-linked annotations 420A, 420B, 420C and 420D (collectively annotations 420) are displayed at one time, such as, for example, an overlay to the graphic design 410. By making all of the annotations visible at one time, a user (e.g., developer) does not have to ‘hunt’ for annotations on a canvas, or risk missing one.

As shown, examples provide that a content of an annotation-linked attribute can correspond to an attribute value. Thus, in some examples, a note-style structure to hold annotation content is not used. Further, attribute-linked annotations 420A-420C include text descriptors relating to the attributes of select design elements, and the attribute 420D displays a measurement (e.g., 180 pixels) between adjacent design elements. The text descriptors can be attributes, as provided by the GDS 100. Alternatively, the descriptors can be generated off of attribute values. Other examples of attribute linked annotations can highlight additional types of attributes, such as font attributes (e.g., size and type), fill color attributes, line attributes, etc.

In examples, attribute-linked annotations can also include attribute-based calculations, where a value reflected by an annotation is a calculation that utilizes one or more attributes (or properties) associated with select design elements. For example, the attribute-linked annotation can include a measurement, reflecting a spacing or padding between select design elements (e.g., in pixel distance), such as between adjacent design elements.

As described with examples, an attribute-linked annotation can be logically linked to the graphic design, and to the particular design element(s) that are the basis for the annotation. If an attribute that is used with the attribute-linked annotation s changed as a result of changes to the graphic design, the attribute value or content reflected by the annotation is automatically updated, to reflect the value of the changed attribute. Likewise, for attribute-linked annotations that include measurements or calculations, when design inputs update the graphic design to change measurements, the contents of such annotations are automatically updated, to include updated measurements for select design elements of that annotation.

FIG. 5A through FIG. 5D illustrate an example design interface for enabling users to create attribute-linked annotations for graphic designs, according to one or more examples. FIG. 5E illustrates an example design interface that is implemented in an alternative mode where attribute-linked annotations are rendered or otherwise made available, according to one or more examples.

In FIG. 5A, a design interface 500 includes a graphic design 510 that is comprised of a plurality of design elements, corresponding to, images, frames and textual elements. The design interface 500 also includes a tool panel 520 to enable the user to view attributes and measurements, and to place attributed-linked annotations on the design interface 510. In an example, the tool panel 520 includes an inspect tool 522 that when selected, causes attributes of the design interface 500 to be displayed over the graphic design 510. Further, the tool panel 520 includes an annotation tool 524 that can be selected to enable the user to specify attribute-linked annotations for specific design elements. As described with FIG. 5E, the attribute-linked annotations can be displayed to developers when the design interface is toggled into an alternative mode (e.g., developer's mode), to enable developers to readily detect fine details of the graphic design 510. In an example show, a user can interact with tool pane 520 to select the annotation tool 524, in order to link an annotation with a select design element 512, to display a value for a particular type of attribute or property.

The tool panel 520 can also include a measurement tool 526 that generates calculates a measurement for a particular design element (relative to another design element or reference). The measurement tool can also reflect padding between adjacent design element. The measurement tool can be used to automatically determine measurements and to generate attribute-linked annotations that include the measurement.

As shown with FIG. 5B through FIG. 5D, the user (e.g., designer) can interact with a design element 512, or corresponding portion of the graphic design 510, to generate an annotation panel 530. In the example shown, the annotation panel 530 is implemented as a floating panel that is displayed adjacent or near the selected design element 512 in response to a designated user input. The annotation panel 530 can be made available when, for example, the user selects the annotation tool 524. The annotation panel 530 enables the user to select an attribute type for a new or existing annotation. In an example show, each property type corresponds to an attribute type. Further, the annotation panel 530 can be generated to automatically determine and display, as part of the annotation tool bar 530, attribute values relevant to selected design elements.

Accordingly, the user can interact with the annotation panel 530 to select one of multiple types of properties for a selected design element 512. The annotation panel 530 can be dynamic, in that it can expand to display a menu of options for selecting properties for the annotation. In an example shown with FIG. 5B and FIG. 5C, the annotations panel 530 is contracted, enabling the user to select to add a first property (e.g., font size) (FIG. 5B), and a second property (FIG. 5C). With each property selection, the attribute panel 530 is expanded to display a set of properties. The user can interact with the annotation tool 530 to select a particular property type. In an example, the value of the property (i.e., the attribute value) for the selected design element 512 is displayed in the annotation tool 530. The annotation tool 530 enables the user to select any of multiple properties, to display a corresponding attribute value relating to the selected design element 512. In an example shown, the property types shown with the annotation panel 530 include, for example, (i) a dimension property, specifying a height or width of the design element on a canvas, (ii) a direction attribute, specifying whether the design element 512 is vertically or horizontally aligned, (iii) an alignment property, specifying a padding (or spacing) attribute relevant to the selected design element 512 (e.g., spacing between design element 512 and other design element), and/or (iv) a fill attribute.

FIG. 5E illustrates the design interface 500 when implemented in an alternative (e.g., developer) mode. In the developer mode, an attribute-linked annotation 540 is displayed over the graphic design 510. The attribute-linked annotation can be displayed automatically, when the design interface 500 is toggled into the alternative developer mode. As shown, the annotation 540 can display attribute values for the design element 512, based on the user's selection of properties from the annotation panel 530. Further, in a variation shown, the attribute-linked annotation 540 can be structured as an overlay object, such as a note. In some variations, the annotation 540 can include text or other content that is manually inserted by one or more users (e.g., designer, developer, etc.).

In examples, the annotation 540 is attribute-linked, meaning the annotation (i) displays a value of a linked attribute when the attribute is displayed (e.g., when the developer mode is implemented), and (ii) when the linked attribute is changed (e.g., as a result of a design user changing the design interface), the annotation automatically updates to reflect the changed value of the linked attribute. Accordingly, when the design element 512 receives an edit that changes an attribute displayed with the annotation, the contents of the annotation also change automatically, to reflect the updated property value of the design element 512.

Among other advantages, an example as shown enables a developer can view the annotation 540 when using the design interface in a developer mode, or to otherwise inspect/write code for implementing the design interface 510 in a production environment.

### Network Computer System

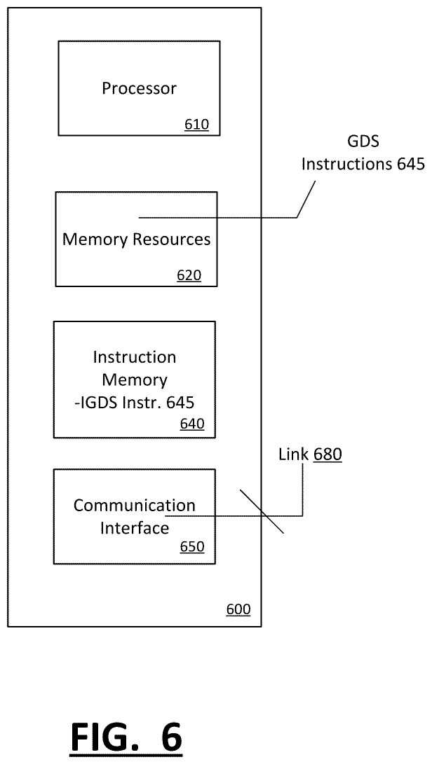

FIG. 6 illustrates a computer system on which one or more embodiments can be implemented. A computer system 600 can be implemented on, for example, a server or combination of servers. For example, the computer system 600 may be implemented as the network computing system 150 of FIG. 1.

In one implementation, the computer system 600 includes processing resources 610, memory resources 620 (e.g., read-only memory (ROM) or random-access memory (RAM)), one or more instruction memory resources 640, and a communication interface 650. The computer system 600 includes at least one processor 610 for processing information stored with the memory resources 620, such as provided by a random-access memory (RAM) or other dynamic storage device, for storing information and instructions which are executable by the processor 610. The memory resources 620 may also be used to store temporary variables or other intermediate information during execution of instructions to be executed by the processor 610.

The communication interface 650 enables the computer system 600 to communicate with one or more user computing devices, over one or more networks (e.g., cellular network) through use of the network link 680 (wireless or a wire). Using the network link 680, the computer system 600 can communicate with one or more computing devices, specialized devices and modules, and/or one or more servers.

In examples, the processor 610 may execute service instructions 622, stored with the memory resources 620, in order to enable the network computing system to implement functionality such as described with the network computing system 150 of FIG. 1.

The computer system 600 may also include additional memory resources (“instruction memory 640”) for storing executable instruction sets for implementing the graphic design system 100 through, for example, the browser application 80. The graphic design system instructions (“GDS instructions 645”) can be embedded with web-pages and other web resources, to enable user computing devices to implement functionality such as described with the GDS 100.

As such, examples described herein are related to the use of the computer system 600 for implementing the techniques described herein. According to an aspect, techniques are performed by the computer system 600 in response to the processor 610 executing one or more sequences of one or more instructions contained in the memory 620. Such instructions may be read into the memory 620 from another machine-readable medium. Execution of the sequences of instructions contained in the memory 620 causes the processor 610 to perform the process steps described herein. In alternative implementations, hard-wired circuitry may be used in place of or in combination with software instructions to implement examples described herein. Thus, the examples described are not limited to any specific combination of hardware circuitry and software.

### User Computing Device

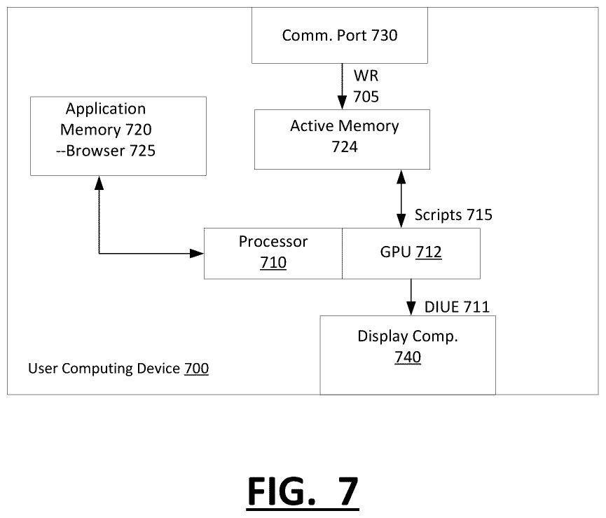

FIG. 7 illustrates a user computing device for use with one or more examples, as described. In examples, a user computing device 700 can correspond to, for example, a work station, a desktop computer, a laptop or other computer system having graphics processing capabilities that are suitable for enabling renderings of design interfaces and graphic design work. In variations, the user computing device 700 can correspond to a mobile computing device, such as a smartphone, tablet computer, laptop computer, VR or AR headset device, and the like.

In examples, the computing device 700 includes a central or main processor 710, a graphics processing unit 712, memory resources 720, and one or more communication ports 730. The computing device 700 can use the main processor 710 and the memory resources 720 to store and launch a browser 725 or other web-based application. A user can operate the browser 725 to access a network site of the network computing system 150, using the communication port 730, where one or more web pages or other resources 705 for the network computing system 150 (see FIG. 1) can be downloaded. The web resources 705 can be stored in the active memory 724 (cache).

As described by various examples, the processor 710 can detect and execute scripts and other logic which are embedded in the web resource in order to implement the graphic design system 100 (FIG. 1). In some of the examples, some of the scripts 715 which are embedded with the web resources 705 can include GPU accelerated logic that is executed directly by the GPU 712. The main processor 710 and the GPU can combine to render a design interface under edit (“DIUE 711”) on a display component 740. The rendered design interface can include web content from the browser 725, as well as design interface content and functional elements generated by scripts and other logic embedded with the web resource 705. By including scripts 715 that are directly executable on the GPU 712, the logic embedded with the web resource can better execute the graphic design system 100, as described with various examples.

### CONCLUSION

Although examples are described in detail herein with reference to the accompanying drawings, it is to be understood that the concepts are not limited to those precise examples. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude having rights to such combinations.

What is claimed is:

1. A computer-implemented method comprising:
maintaining a graphic design data set for a graphic design, the graphic design data set structuring the graphic design as a collection of layers, wherein each layer corresponds to an object, a group of objects or a type of object, and each layer is associated with a set of attributes, including a text identifier;
in response to a user interaction with a selected layer of the collection, generating an annotation that indicates or is based on a selected attribute of the selected layer; and
logically linking the annotation with the selected attribute, such that an update to the selected layer of the collection automatically updates the annotation.

2. The method of claim 1, further comprising:
providing multiple rendering modes to view the graphic design, the multiple modes including a design mode and a developer mode, wherein in the developer mode, all annotations created for the graphic design are concurrently viewable.

3. The method of claim 1, wherein the annotation corresponds to an alphanumeric entry that includes or corresponds to an attribute value.

4. The method of claim 1, wherein logically linking the annotation with the selected attribute includes, in response to a user providing input to update the graphic design to change the selected attribute, automatically updating the annotation to reflect the change to the selected attribute.

5. The method of claim 4, wherein the annotation includes a numeric value corresponding to the selected attribute, and in response to the selected attribute being changed, the numeric value also changes to coincide with the change in the selected attribute.

6. The method of claim 4, wherein the selected attribute corresponds to one or more of a font size or type, a spacing or padding value or dimension, or other attribute.

7. The method of claim 1, wherein the selected attribute includes a measurement.

8. The method of claim 1, further comprising:
enabling the user to toggle each annotation of the graphic design between visible and invisible, and filter annotations by type or content.

9. A network computer system comprising:
one or more processors;
memory to store instructions;
wherein the one or more processors execute the instructions to perform operations that include:
maintaining a graphic design data set for a graphic design, the graphic design data set structuring the graphic design as a collection of layers, wherein each layer corresponds to an object, a group of objects or a type of object, and each layer is associated with a set of attributes, including a text identifier;
enabling a rendering mode in which attribute values of individual layers are displayed with the graphic design; and
in response to a user selecting a displayed attribute value, generating a annotation that indicates the displayed attribute;
logically linking the annotation with the displayed attribute.

10. The computer system of claim 9, wherein the operations further comprise:
providing multiple rendering modes to view the graphic design, the multiple modes including a design mode and a developer mode, wherein in the developer mode, all annotations created for the graphic design are concurrently viewable.

11. The computer system of claim 9, wherein the annotation corresponds to an alphanumeric entry that includes or corresponds to an attribute value.

12. The computer system of claim 9, wherein logically linking the annotation with the selected attribute includes, in response to a user providing input to update the graphic design to change the selected attribute, automatically updating the annotation to reflect the change to the selected attribute.

13. The computer system of claim 12, wherein the annotation includes a numeric value corresponding to the selected attribute, and in response to the selected attribute being changed, the numeric value also changes to coincide with the change in the selected attribute.

14. The computer system of claim 9, wherein the selected attribute corresponds to one or more of a font size or type, a spacing or padding value or dimension, or other attribute.

15. The computer system of claim 9, wherein the selected attribute includes a measurement.

16. The computer system of claim 9, wherein the operations further comprise:
enabling the user to toggle each annotation of the graphic design between visible and invisible, and filter annotations by type or content.

17. A non-transitory computer-readable medium that stores instructions, which when executed by one or more processors of a computer system, cause the computer system to perform operations that include:
maintaining a graphic design data set for a graphic design, the graphic design data set structuring the graphic design as a collection of layers, wherein each layer corresponds to an object, a group of objects or a type of object, and each layer is associated with a set of attributes, including a text identifier;
enabling a rendering mode in which attribute values of individual layers are displayed with the graphic design; and
in response to a user selecting a displayed attribute value, generating a annotation that indicates the displayed attribute;
logically linking the annotation with the displayed attribute.

18. The non-transitory computer-readable medium of claim 17, wherein the operations further comprise:
providing multiple rendering modes to view the graphic design, the multiple modes including a design mode and a developer mode, wherein in the developer mode, all annotations created for the graphic design are concurrently viewable.

19. The non-transitory computer-readable medium of claim 17, wherein the annotation corresponds to an alphanumeric entry that includes or corresponds to an attribute value.

20. The non-transitory computer-readable medium of claim 17, wherein logically linking the annotation with the selected attribute includes, in response to a user providing input to update the graphic design to change the selected attribute, automatically updating the annotation to reflect the change to the selected attribute.
